(19) United States
(12) Patent Application Publication
(10) Pub. No.: US 2014/0229994 A1
(43) Pub. Date: Aug. 14, 2014

(54) TELEVISION SYSTEM

(71) Applicants: David Fell, Cambridge (GB); Simon Middleton, Cambridge (GB)

(72) Inventors: David Fell, Cambridge (GB); Simon Middleton, Cambridge (GB)

(73) Assignee: Espial Limited, Cambridge (GB)

(21) Appl. No.: 14/125,210

(22) PCT Filed: Jun. 11, 2012
(86) PCT No.: PCT/EP2012/061029

§ 371 Date: Feb. 28, 2014

(30) Foreign Application Priority Data
Jun. 10, 2011 (GB) 1109715.1

(51) Int. Cl. H04N 21/435; H04N 21/436; H04N 21/81; H04N 21/422

(52) U.S. Cl. CPC H04N 21/435; H04N 21/42209; H04N 21/436; H04N 21/81
USPC 725/54; 725/131

(57) ABSTRACT

A system comprising: a first user terminal comprising a television receiver for receiving a selected television channel, the television channel being selected by a first user activation and comprising a main video stream, and the first terminal further comprising a first controller and an output for outputting the main video stream of the selected television channel to a first screen; and a second user terminal comprising a second screen, a wireless transceiver operable to establish a wireless connection with the first terminal, and a second controller configured to communicate with the first controller via the wireless connection; wherein the television receiver of the first terminal is arranged to receive metadata relating to interactive content associated with the main video stream, and the first controller is operable to forward at least a portion of the metadata to the second terminal via said wireless connection; and the second controller is configured to process said portion of metadata and to output the interactive content to the second screen, such that the interactive content is displaced to the screen of the second terminal whilst the main video stream of the television channel continues to be displayed on the screen of the first terminal.

### FIELD OF THE INVENTION

The present invention relates to the processing of supplementary interactive content in a television system.

### BACKGROUND

A conventional television system is illustrated schematically in FIG. 1a. The system comprises a television network 2 such as a satellite television network in which signals are broadcast wirelessly via one or more satellites, a terrestrial television network in which signals are broadcast wirelessly via one or more land-based repeater stations, or a cable television network.

The system further comprises a set-top box 4 and a television screen 6. Alternatively the components of the two devices 4, 6 can be combined into the same housing to form a television set, but for illustrative purposes the following will be described by reference to an arrangement comprising a separate set-top box 4 and screen 6.

The set-top box (STB) 4 comprises a television receiver having a receiving interface 3 in the form of one or more of: an input for connecting to a radio-frequency antenna 5 for receiving signals over a terrestrial television network, an input for connecting to a satellite dish for receiving signals over a satellite television network, and/or a cable input for receiving signals over a cable television network. The television receiver of the set-top box 4 further comprises a demultiplexer 8 having an input operatively coupled to the interface 3.

The network interface 3 is arranged to receive multiple concurrent television channels, at least in that the physical signals of multiple channels arrive concurrently at the location of the interface. However, only a certain selected channel will be desired by the user. To this end, the demultiplexer 8 is arranged to receive an indication of the selected television channel from the user and to extract the data of that television channel for signal processing and output to the television screen 6. The interface 3 may be arranged to receive a plurality of different television channels on one or more frequency bands. On a given frequency band, the television channels may be interleaved in time into a transport stream comprising multiple channels in different interleaved time slots. In this case the demultiplexer 8 comprises a deinterleaver arranged to extract the data of the selected television program from its respective time slots (note therefore that channels interleaved into a transport stream are considered to be effectively concurrent for the purpose of this application). In the case of multiple frequency bands, the demultiplexer 8 comprises a television tuner arranged to tune to the frequency band of the selected television channel. It is also possible that both time and frequency division multiplexing are used, such that each of a plurality of frequency bands carries a different respective transport stream, the transport stream on each frequency band comprising a plurality of television channels. In this case the demultiplexer 8 comprises both a television tuner and a de-interleaver.

The set-top box 4 further comprises a signal processing module 10 having an input operatively coupled to the output of the demultiplexer 8, and a television screen output port 12 such as a coaxial output, SCART or HDMI port, etc. operatively coupled to the output of the signal processing module 10 (or in the case of a television set the output 12 is an internal connection to the television screen). The television channels will have been transmitted over the network 2 in encoded form, to compress the data of those channels into a smaller number of bits to save on network resources when transmitted over the television network 2. The signal processing module comprises a decoder arranged to decode the content of the selected television channel and thereby decompress the data for output to the screen 6 via the output port 12. The television channels may also have been transmitted in encrypted form to provide security, e.g. so that only authorised users can view them, in which case the signal processing module 10 comprises a decryption algorithm for decrypting the channel, e.g. given an appropriate decryption key.

The signal processing module 10 is preferably implemented in the form of a portion of executable program code stored on a storage medium of the set-top box 4 and arranged for execution on a processor of the set-top box 4. However, the option of some or all of its functionality being implemented in dedicated hardware circuitry is not excluded. The demultiplexer 8 may also be implemented wholly or partially in executable code, though in the case of a tuner it may comprise at least some dedicated tuner circuitry.

Thus a plurality of television channels are concurrently made available in multiplexed form, from which a selected channel is to be demultiplexed, decoded and output to a screen 6. Conventionally a user selects the desired channel by means of the television 6 or set-top box 4, e.g. using a dedicated infra-red remote control unit (not shown) associated with the television 6 or set-top box 4.

An arrangement consistent with that of FIG. 1a may be represented schematically as shown in FIG. 1b. Here a plurality of multiplexed television channels C are broadcast via a head-end 1 being a component of the television network 2, and received at an antenna or dish 5. The channels C are thus made available, still in multiplexed form, to the set-top box 4 (or TV set) connected to that antenna or dish 5 (note that the parallel lines in FIG. 1b are schematic and the multiple channels are still multiplexed onto the same line). FIG. 1b also illustrates the fact that a given antenna or dish 5 may be connected to multiple instances 4a, 4b of a set-top box 4 each connected to a respective screen 6a, 6b (or one or more of these could be an integrated TV set). Each of the one or more set-top boxes 4 or TV sets is equipped with its own respective demultiplexer 8 and signal processing module 10 so as to demultiplex and output its own respective selected one of the channels.

An alternative arrangement is shown in FIGS. 1c and 1d. FIG. 1d illustrates an IP (Internet Protocol) multicast scenario. In this case a provider of an IP television service operates an IP head-end 1′, which is connected to a server 11 storing IP based television content, and also connected to a home gateway 5′ such as a wireless home router or other local router via a suitable connection. This connection between the IP head-end 1′ and home gateway 5′ may comprise a broadband phone line or a dedicated connection of the provider such as an optical or cable connection, or could comprise stretches of a combination of any of these. Further, a plurality of set-top boxes 4a, 4b and/or television sets are connected to the home gateway 5′ via a wired or wireless connections. The IP head-end 1′ thus makes a plurality of television channels available to the one or more STBs 4 or television sets via the home gateway 5′. In this way the IP based head-end 1′, server 11 and connections to the home gateways provide an alternative form of television network.

As an additional service the IP television provider may also provide general Internet access onto the open Internet 20 via the connection between the home gateway 5 and the IP head-end 1′, or alternatively the user may have to access the Internet via a separate connection and/or separate provider. If Internet access is via the provider's own head-end 1′, the television network formed by the head-end 1′, server 11 and connection to the gateway 5′ may still be considered a private network distinguishable from the rest of the open Internet 20, for example in that all the nodes within the private television network are configured according to a dedicated IP television protocol or standard; and/or in that the television network forms a closed network to which access is restricted to only a certain set of subscribers (e.g. because a process of authenticating user credentials is required before the head-end 1′ allows access to a particular gateway 5′ or STB 4, and/or the gateway 5′ or STB 4 requires a decryption key to decrypt the content from the television network).

Referring to FIG. 1c, in the case of IP multicasting the set-top box 4 is similar to that shown in FIG. 1a except that the interface 3 of the STB's television receiver comprises a modem and suitable packet protocol, and its demultiplexer 8 comprises a packet filter. Each STB 4 (or television set) may request its own respective selected one of the multiple channels available from the IP head-end 1′ via the home gateway 5′, e.g. a first STB 4a requesting one channel and a second STB 4b on the same home network requesting another, different channel. The home gateway 5′ therefore receives multiple selected channels c for the different respective STBs 4a, 4b. The home gateway 5′ will comprise its own packet filter in order to attempt to direct only those packets required by the first STB 4a to the first STB 4a and only those packets required by the second STB 4b to the second STB 4b. However, in reality the home gateway 5′ will not be 100% efficient at filtering out the packets destined for STB 4a from those intended for STB 4b and vice versa. Hence the first STB 4a requires a demultiplexer 8 in the form of a packet filter in order to discard the packets intended for the second STB 4b, and similarly the second STB 4b requires a packet filter in order to discard the packets intended for the first STB 4a (and so on if there are three or more television receiving devices connected to the home network).

A distinction between broadcast and multicast is that a multicast is a point-to-point transmission (albeit point-to-multipoint) whereby each item of content is transmitted to an identified address in response to a request for the content, the transmitter knowing the address and including that address in header information in the transmitted stream. A broadcast on the other hand is transmitted “indiscriminately” in that multiple television channels are provided to the location of a receiving interface without those television channels having been requested by any particular receiving terminal at that location (even if a subscription and decryption key are required to make meaningful use of the channels). Information identifying a destination address typically would also not be included in a broadcast.

Another possibility nowadays is that the user requests and receives a single specified channel “on demand” directly from a television provider over an IP network. In this case the television receiver comprises a suitable modem.

By whatever means the data is delivered, each television channel conventionally comprises one or more elementary streams in the form of a video stream and one or more audio streams (e.g. alternate language soundtracks). Subtitle streams are also common. A given television channel is defined by its user content, being a consistent stream of content from the perspective of the user, and may also be identified by a respective television channel identifier included in metadata carried in the multiplexed signal.

Furthermore, in some modern television systems one or more of the television channels may comprise embedded metadata associated with the channel, such as metadata defining interactive content of that channel. The metadata may be associated with a specific channel identifier. For example, in a “hybrid” television system such as HbbTV (Hybrid Broadcast Broadband TV), a set-top box or television set will be equipped with an interface for accessing the Internet, such as a wired modem or wireless transceiver connecting to a wireless router in the home. Metadata in the form of a URL can then be embedded in a broadcast channel, linking to supplementary content on the Internet. When a user activates a control at the relevant time during the program, the set-top box or TV set can then retrieve the supplementary content from a server via the Internet for display on the television screen, either replacing or in conjunction with display of the current program. For example this could be used in commercials or during product placement to link to further information on the advertised product. Another option is that the metadata may comprise a link that references content carried in the broadcast stream itself, as opposed to a server. Data streams carrying interactive content are typically referred to as “carousels”.

Interactive content may have an interactive application associated with it running on the set-top box or television. The interactive application in HbbTV (and UK MHEG) can be (and usually is) automatically run when the channel is selected. For example this is what shows a red button in the corner of the screen. Normally the application then runs silently in the background until the user presses the red button (or such like) to display and interact with the associated interactive content. Although for radio channels, and theoretically on any channel, the application may immediately go into a full screen interactive mode without this being specifically initiated by the user. “Interactive content” as used herein may refer to either the initially displayed supplementary content by which the user interacts (e.g. a user interface screen or overlay specified by the received metadata), or the supplementary content summoned by a user interaction (e.g. a downloaded image or text linked to by a URL supplied in the metadata).

In addition to the metadata associated with particular respective channels, a broadcast may also include one or more separate data streams associated with the broadcast as a whole, i.e. associated with a set of channels and shared between all of those channels. These one or more data streams may be referred to as the “service information”. This typically comprises an electronic program guide (EPG) which the user can view via his or her STB or TV.

### SUMMARY

In existing hybrid television there is an assumption that interactive content accessed via the set-top box or television set is also to be displayed on that television screen of that box or set. However, the inventors believe there is a problem with interactive content in that it is intrusive, i.e. it obscures the main video content of the channel (the actual program, film or commercial being viewed). This is especially so when there are multiple viewers present but only one of them is interested in the interactive content whilst others would prefer to continue to concentrate on the main program.

Some developers have provided EPG applications that can run on a tablet style computer, but these simply operate by downloading a separate EPG to the tablet from a web server via the tablet's own internet connection. Therefore these applications do not provide access to true interactive content, i.e. interactive content that can be defined by the broadcaster or provider of the channel and delivered along with the channel itself. Furthermore, such applications require cumbersome mechanisms to try to synchronise the guide with the actual timing of the programming. For example one existing system requires a number of sample frames of the program to be provided to the server where a video pattern matching algorithm is applied to try to determine what is being watched. This is cumbersome, prone to error, and may involve an undesirable time lag.

It is an aim of the present invention to provide true interactive content in a non-intrusive manner.

According to one aspect of the present invention, there is provided a system comprising: a first user terminal comprising a television receiver for receiving a selected television channel, the television channel being selected by a first user activation and comprising a main video stream, and the first terminal further comprising a first controller and an output for outputting the main video stream of the selected television channel to a first screen; and a second user terminal comprising a second screen, a wireless transceiver operable to establish a wireless connection with the first terminal, and a second controller configured to communicate with the first controller via the wireless connection; wherein the television receiver of the first terminal is arranged to receive metadata relating to interactive content associated with the main video stream, and the first controller is operable to forward at least a portion of the metadata to the second terminal via said wireless connection; and the second controller is configured to process said portion of metadata and to output the interactive content to the second screen, such that the interactive content is displaced to the screen of the second terminal whilst the main video stream of the television channel continues to be displayed on the screen of the first terminal.

In a particularly preferred embodiment, the metadata may include an indicator indicating whether the first terminal or the second terminal has been specified by a provider for output of the interactive content, and at least one of the first controller and the second controller may be configured to process said indicator. At least one of the first controller and the second controller may be configured such that said processing comprises automatically displacing the interactive content to the second terminal on condition that the indicator indicates the second terminal.

Hence the broadcaster or provider of the interactive content is advantageously enabled to specify an output device for the interactive content.

In further embodiments, the interactive content may comprise content to be accessed in response to a second user activation supplied during output of the main video stream to the first screen; and the second controller may be configured to process said portion of metadata and to output the interactive content to the second screen in response to the second user activation. In a combination of this embodiment with the case where the displacement of interactive content is also automatic, the automatic displacement may occur after once the second user interaction has been detected.

The second controller may be configured to receive said second user activation via a user input of the second terminal.

The second controller may be configured to request said portion of metadata from the first terminal in response to the second user activation, and the first controller may be configured to transmit the portion of metadata to the second terminal via the wireless connection in response to said request.

The metadata may comprise a link to a server, said portion may comprise at least the link, and the second controller may be configured to retrieve the interactive content from the server via a packet-based network based on the link as received over said wireless connection.

The metadata may define a time window defined relative to the main video stream, and at least one of the first controller and the second controller may be configured such that access to the interactive content is conditional on said second user activation being supplied at a time consistent with said time window.

The metadata may be embedded in the television channel.

The television receiver of the first terminal may be further arranged to receive a data channel comprising an electronic program guide, in addition to said television channel and said metadata.

The second controller may be further configured to receive the electronic program guide from the television receiver of the first terminal via the wireless connection, and to operate the electronic program guide via the screen of the second terminal.

The second controller may be further configured to receive a user interface from the first terminal via the wireless connection, and to operate the user interface via the screen of the second terminal.

The controller on the second terminal may be further configured to schedule recordings of television programs on the first terminal and control playback of the recordings via the wireless connection.

The television receiver may comprise: a receiving interface at which a plurality of concurrent multiplexed television channels are concurrently made available from a television network, each television channel comprising a respective video stream, and a demultiplexer arranged to demultiplex the selected television channel from amongst said television channels.

The receiving interface may comprise an input from at least one of a satellite dish and a radio-frequency antenna, at which the plurality of television channels are made available on a plurality of different frequency bands, and the demultiplexer may comprise a television tuner operable to tune to the frequency band of the selected television channel.

The first terminal may comprise a wireless transceiver other than said television receiver, for establishing said wireless connection with the second terminal.

At least one of the first terminal and the second terminal may comprise a network interface other than the receiving interface from the television network, the network interface providing access to said packet-based network, being a network other than said television network, for retrieval of the interactive content from said server.

The television receiver may be arranged to receive the television channel from a private television network.

The first terminal may be one of: a television set comprising said screen, and set-top box for plugging into said television screen.

The second terminal may be a portable terminal. The second terminal may be one of a tablet and a laptop computer.

According to another aspect of the present invention, there is provided a first terminal configured according to the features of the first terminal of any of the above systems.

According to another aspect of the present invention, there is provided a second terminal configured according to the features of the second terminal of any of the above systems.

According to another aspect of the present invention, there is provided a computer program product for displacing interactive content from the first terminal to a screen of the second terminal, the computer program product being embodied on a non-transient computer-readable medium and configured so as when executed on a processor to perform the operations of the first controller according to any of the above system features.

According to another apsetc of the present invention, there is provided a computer program product for displacing interactive content from the first terminal to a screen of the second terminal, the computer program product being embodied on a non-transient computer-readable medium and configured so as when executed on a processor to perform the operations of the second controller according to any of the above system features.

### BRIEF DESCRIPTION OF THE DRAWINGS

For a better understanding of the present application and to show how it may be put into effect, reference is made by way of example to the accompanying drawings in which:

FIG. 1a is a schematic block diagram of a television system,

FIG. 1b is another schematic block diagram of a television system

FIG. 1c is a schematic block diagram of another television system,

FIG. 1d is another schematic block diagram of a television system,

FIG. 2a is a schematic block diagram of an improved television system,

FIG. 2b is a schematic block diagram of an improved television system,

FIG. 3 is a schematic block diagram of a first terminal,

FIG. 4 is a schematic block diagram of a second terminal, and

FIG. 5 is a schematic representation of a television transmission comprising embedded metadata.

### DETAILED DESCRIPTION OF PREFERRED EMBODIMENTS

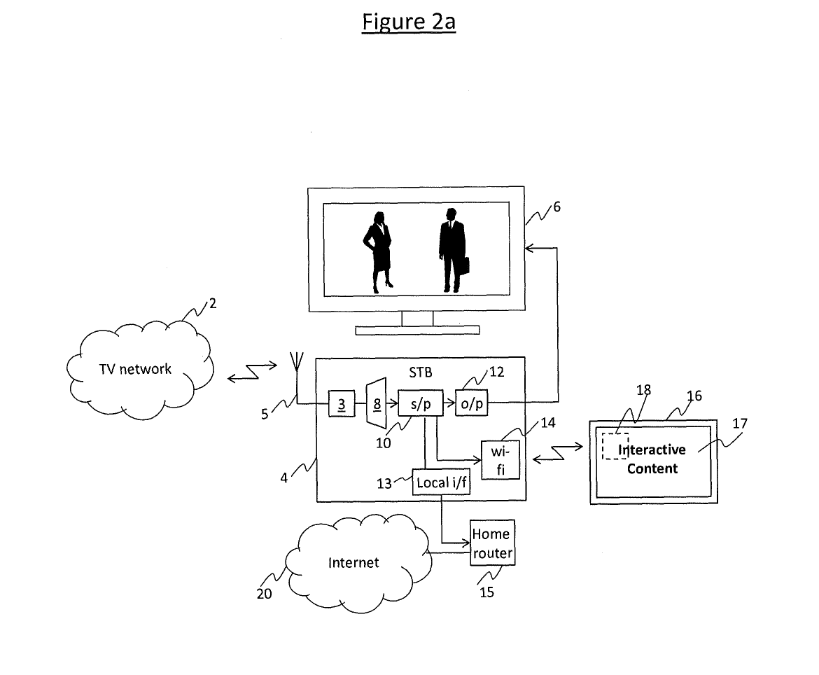

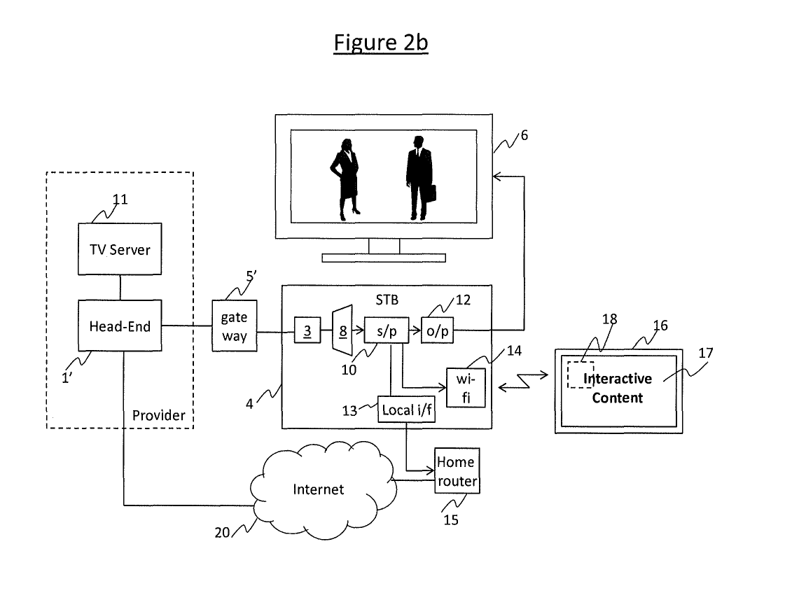

An improved television system in accordance with an embodiment of the present invention is illustrated schematically in FIG. 2a.

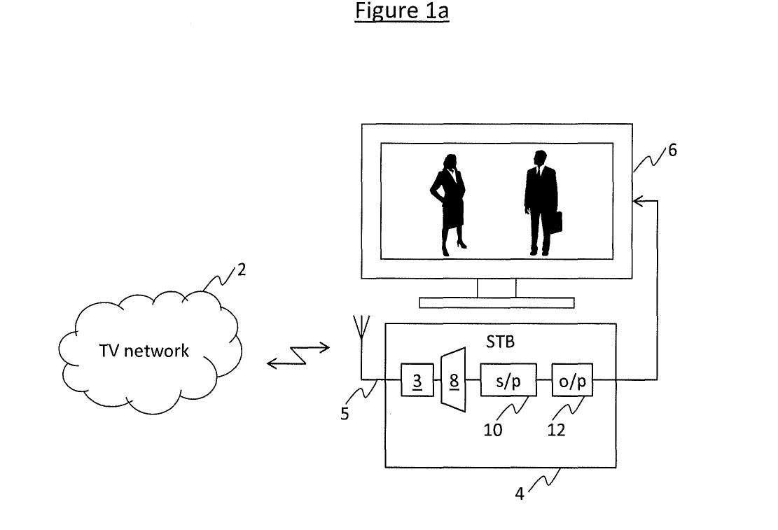

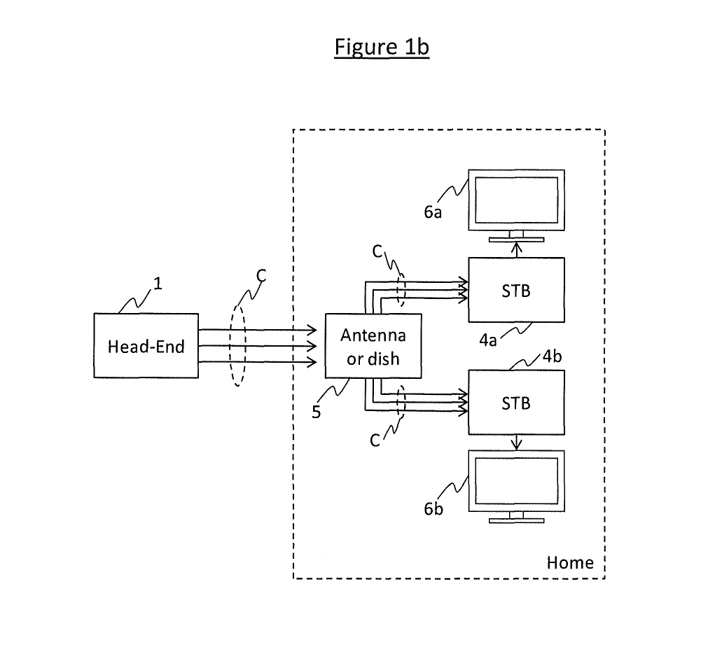

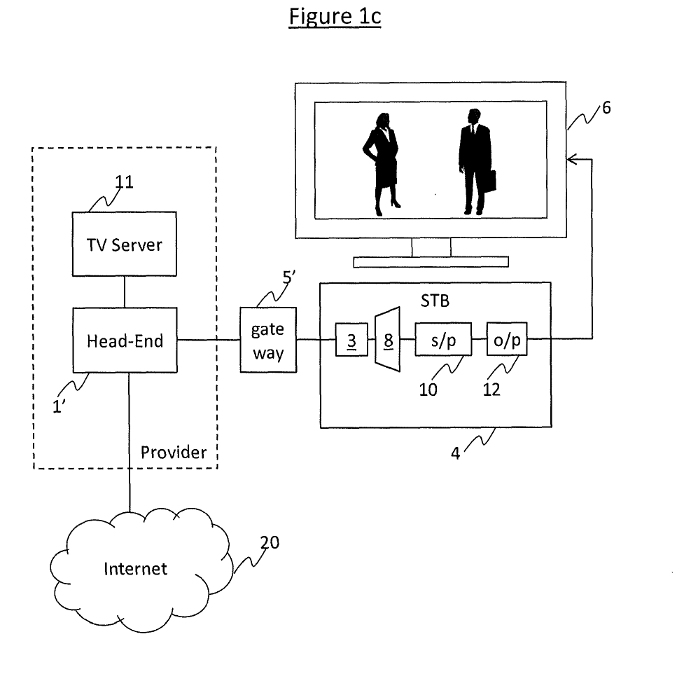

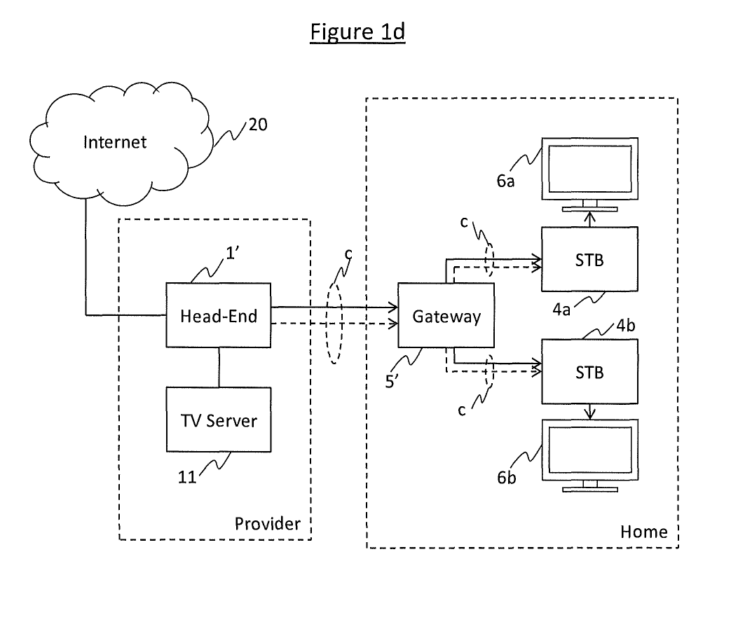

As in FIG. 1a the system comprises a television network 2 such as a satellite television network in which signals are broadcast wirelessly via one or more satellites, a terrestrial television network in which signals are broadcast wirelessly via one or more land-based repeater stations, or a cable television network.

The system further comprises a first user terminal in the form of a set-top box 4, and a television screen 6. Alternatively the components of the two devices 4, 6 can be combined into the same housing to form a television set, but again for illustrative purposes the following will be described by reference to an arrangement comprising a separate set-top box 4 and screen 6.

In addition, the system further comprises a second user terminal 16 in the form of a portable computer, such as a laptop computer or more preferably a tablet style computer. The following may be described in terms of a tablet for illustrative purposes, but it will be appreciated that other kinds of computer could equally be used as the second terminal 16.

The second terminal 16 is a separate terminal than the first terminal 4, by which is meant that they are separate units, i.e. housed within a separate housing (casing) and having separate hardware resources such as separate power supplies and separate processors, and each being capable of operating autonomously.

The set-top box (STB) 4 comprises a television receiver having and interface 3 in the form of one or more of: an input for connecting to a radio-frequency antenna for receiving signals over a terrestrial television network, an input for connecting to a satellite dish for receiving signals over a satellite television network, and/or a cable input for receiving signals over a cable television network. The television receiver of the set-top box 4 further comprises a demultiplexer 8 having an input operatively coupled to the interface 3.

The network interface 3 is arranged to receive multiple concurrent television channels in the sense described above in relation to FIGS. 1a and 1b; and the demultiplexer 8 is arranged to receive an indication of the selected television channel from the user and to extract the data of that television channel for signal processing and output to the television screen 6. The set-top box 4 further comprises a signal processing module 10 having an input operatively coupled to the output of the demultiplexer 8, and a television screen output port 12 such as a coaxial output, SCART or HDMI port, etc. operatively coupled to the output of the signal processing module 10. The signal processing module comprises a decoder arranged to decode the content of the selected television channel for output to the screen 6 via the output port 12, and may also comprise a security module for decrypting the selected television channel before output.

Again, the signal processing module 10 is preferably implemented in the form of a portion of executable program code stored on a storage medium of the set-top box 4 and arranged for execution on a processor of the set-top box 4. However, the option of some or all of its functionality being implemented in dedicated hardware circuitry is not excluded. The demultiplexer 8 may also be implemented wholly or partially in executable code, though in the case of a tuner it may comprise at least some dedicated tuner circuitry.

In addition, the set-top box 4 comprises another wireless transceiver 14 being of a kind other than that formed by the interface 3 and demultiplexer 8, i.e. other than a television receiver for receiving signals over the television network 2. Preferably the transceiver 14 is a short range or ad-hoc wireless transceiver such as a wi-fi or Bluetooth transceiver, as might be used to connect to a home network or other local area network (LAN). The following may be described in terms of a wi-fi transceiver for illustrative purpose, but it will be appreciated that other kinds could be used for the additional transceiver 14.

Furthermore, the set-top box may comprise an interface to a wide area Internet (inter-network) 20 such as the Internet. This interface may be via a separate local wired interface 13 in the set-top box 4, e.g. to a local network element 15 which connects onwards to the Internet 20 via a telephone land line or other suitable connection. The local network element may comprise an ethernet hub 15 and the interface 13 may comprise an ethernet interface connecting to that hub. Alternatively or additionally, a local network element 15 may comprise a wireless router and the set-top box 4 may be arranged to connect to the Internet 20 via the wireless transceiver 14 a wireless router 15 on a home or local area network. The wireless access and router functionality of the element 15 could be combined into one unit or implemented in separate units.

Turning to the second terminal 16, this comprises a wireless transceiver 18, e.g. wi-fi or Bluetooth, to complement the wireless transceiver 14 on the first terminal 4, allowing a wireless connection to be established between the first and second terminals 4, 16. This wireless connection 14, 18 may be via one or more intermediate elements such as the wireless home router 15, e.g. in the case where the terminals 4, 16 communicate on a wireless home network such as a wi-fi network. Alternatively the wireless connection 14, 18 could be direct, e.g. in the case of a Bluetooth. The second terminal 16 also comprises its own screen 17.

The second terminal 16 may also be arranged to connect to the Internet 20. The second terminal 18 may be operable connect to the Internet 20 via its wireless connection with the first terminal 4, i.e. via the wireless transceivers 18 and 14 and the wired modem 13 on the first terminal 4. For example this could be the case if the transceivers 14, 18 comprise Bluetooth transceivers. More preferably however, the second terminal 16 may be operable to connect to the Internet 20 via a separate wireless connection between the wireless transceiver 18 and the home router 15, e.g. if the transceivers 14, 18 comprise wi-fi transceivers on a wi-fi home network; or indeed by a separate cellular connection.

An alternative arrangement is shown in FIG. 2b. Here the broadcast television network 2 and antenna 5 are replaced (or supplemented) with a gateway 5′ and IP television network formed by an IP head-end 1′, a connection between the head-end 1′ and a gateway 5′, and television channel server 11 storing the television channel content and being connected to the head-end 1′. The components 1′, 5′ and 11 are arranged in a manner analogous to that described in relation to FIGS. 1c and 1d. The set-top box 4 may be similar to that described in relation to FIG. 2a, except that its television receiver comprises a receiving interface 3 in the form of a suitable modem and IP protocol, and a demultiplexer 8 in the form of a packet filter.

In one embodiment the connection between the gateway 5′ and the receiving interface 3 of the set-top box 4 may be a dedicated connection such as a cable or optical connection or to a dedicated television network delivering television services via IP or other such packet protocol, and the television interface 3 may comprise a corresponding dedicated TV modem. In this case the set-top box 4 preferably comprises a separate interface 13 or 14 providing access to the Internet 20. In an alternative embodiment, as an additional service the television provider may enable Internet access via the connection between the interface 3, gateway 5′ and head-end 1′. In this case the television interface 3 may comprise a more generic modem. The set-top-box may or may not comprise a separate generic interface 13 or 14 for accessing the Internet 20 directly via a different provider.

In either embodiment, the second terminal 16 is operable to access the Internet 20 via its wireless transceiver 18 and one or both of the set-top box 4 or the wireless hub or router 15. When via the set-top box 4, this may be via the wireless transceiver 14 and one or both of the interfaces 3, 13 or 14.

In the embodiment where Internet access is provided via the connection between the interface 3, gateway 5′ and head-end 1′, the television network formed by the head-end 1′, server 11 and connection to the gateway 5′ may still form a separate, private network that is distinguishable from the rest of the open Internet 20. This may be manifested in that each of the network elements or nodes of the private television network such as the head-end 1′, server 11 and gateway 5′ are configured according to a special, dedicated IP standard or protocol. Alternatively or additionally this may be manifested in that the private network is restricted to a defined subset of users (smaller than the total number of users of the Internet 20), who may be referred to as subscribers. For example an element of the television network such as the head-end 1′ or server 11 may maintain a list of subscribers and be configured to only supply content and/or accept requests from terminals 4 or gateways 5′ having an address corresponding to a listed subscriber, and/or the user of a terminal 4 may be required to submit credentials such as a username and/or password and thereby participate in an authorisation procedure whereby an element of the television network such as the head-end 1′ or server 11 may verify whether the credentials correspond to a listed subscriber and allow access to television content on that condition. Another possibility is that the private television network may distribute television content that is encrypted with one ore more encryption keys (e.g. a different respective key for each channel or set of channels), such that only those boxes 4 or gateways 5′ that have been provided with a corresponding decryption key are able to access that content.

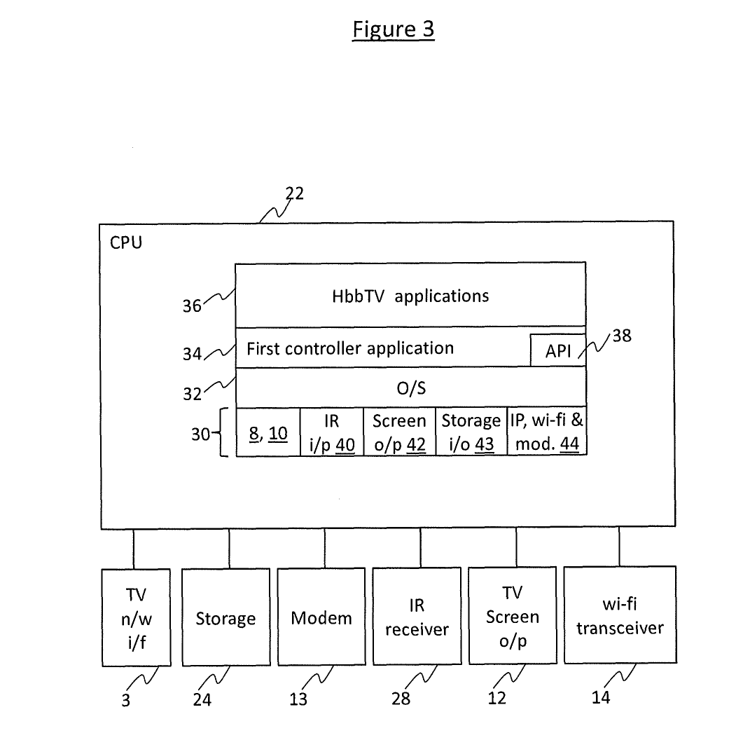

Further details of the first terminal 4, e.g. STB, are shown schematically in FIG. 3.

The first terminal 4 comprises a processor (CPU) 22 in the form of one or more processing cores, and a non-transient (non-volatile) storage medium 24 such as a magnetic storage medium (hard drive) or electronic storage medium (e.g. flash memory) operatively coupled to the processor 22. The first terminal 4 may further comprises a local wired interface 13 such as an ethernet interface, infra red (IR) receiver 28 for receiving control signals from an IR remote control unit, the screen output port 12 (or in the case of a TV set an internal connection to the screen 6), the wi-fi or other such local wireless transceiver 14, and the television interface 3 to the TV network 2 (but not necessarily all of these together).

The storage medium 24 stores a plurality of portions of executable program code, arranged for execution on the processor 22 (and shown schematically within the processor 22 in FIG. 3 to represent running on the processor).

The program code may be considered to comprise an input-output (i/o) layer 30, an operating system layer 32, a middleware layer 34, and an application layer 36. The application layer 36 comprises one or more hybrid TV applications, e.g. HbbTV applications, such as a TV user interface application and further applications allowing additional functionality like web access and interactive services to be accessed via the set-top box 4 and/or television 6. The middleware layer 34 comprises a first television controller application in accordance with a preferred embodiment of the present invention, the function of which will be described shortly. The i/o layer 30 comprises a plurality of signal processing algorithms and drivers allowing the applications 34, 36 to communicate with the hardware resources 3, 12, 13, 14, 24 and 28, mediated via the operating system 32. The i/o layer 30 comprises the signal processing code 10 and de-multiplexing code 8 (in embodiments in addition to demultiplexing circuitry) for receiving a television channel from the TV network 2, an IR interface driver 40 for receiving signals from the remote control unit, a TV screen driver 42 for outputting video and graphics to the TV screen 6, a storage driver 43 for communicating with the storage device 24, and an IP protocol (or such like) and associated hardware drivers 44 for communicating with the second terminal 16 and/or router 15 via the wireless transceiver 14 and/or for accessing the Internet via wired interface 13.

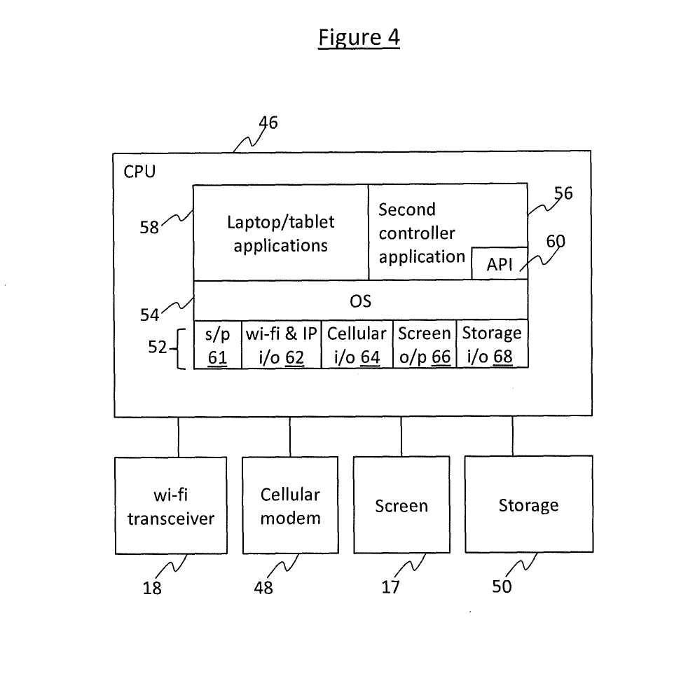

Further details of the second terminal 16, e.g. tablet, are shown schematically in FIG. 4.

The second terminal 16 comprises a processor (CPU) 46 in the form of one or more processing cores, and a non-transient (non-volatile) storage medium 50 such as a magnetic storage medium (hard drive) or electronic storage medium (e.g. flash memory) operatively coupled to the processor 46. The second terminal 16 may further comprises a cellular modem 48, screen 17, and the complementary wi-fi or other such local wireless transceiver 18.

The storage medium 50 stores a plurality of portions of executable program code, arranged for execution on the processor 46 (and shown schematically within the processor 46 in FIG. 4 to represent running on the processor).

This program code may be considered to comprise an input-output (i/o) layer 52, an operating system layer 54, and an application layer 56, 58. The application layer comprises one or more conventional applications 58 such as a web browser, games, email client etc. The application layer on the second terminal 16 also comprises a second television controller application 56 to complement the first television controller application 34 on the first terminal 4 in accordance with a preferred embodiment of the present invention, the function of which will be described shortly. The i/o layer 52 comprises a plurality of signal processing algorithms and drivers allowing the applications 56, 58 to communicate with the hardware resources 17, 18, 48 and 50, mediated via the operating system 54. The i/o layer 52 comprises a screen driver 66 for outputting video and graphics to the computer screen 17, a storage driver 68 for communicating with the storage device 50, a wi-fi transceiver driver and IP protocol (or such like) 62 for communicating with the first terminal 4 and/or router 15 via the wireless transceiver 18, a signal processing module 61, a cellular modem driver and protocol stack 64 for communicating with a cellular network, e.g. 3GPP network, so as to engage in calls or as an alternative route for internet access.

The middleware controller application 34 may comprise an application programming interface (API) 36 facilitating communication with the complementary second controller application 56 via the operating system 54 and/or any other relevant protocols of the second application. Similarly, the second controller application 56 may comprise an API 60 facilitating communication via the operating system 30 and/or any other relevant protocols on the first terminal 4.

In operation, when executed on the respective processors, the television controller applications 34, 56 operate in conjunction with one another and the other appropriate components described above to perform a process in accordance with a preferred embodiment of the present invention as follows.

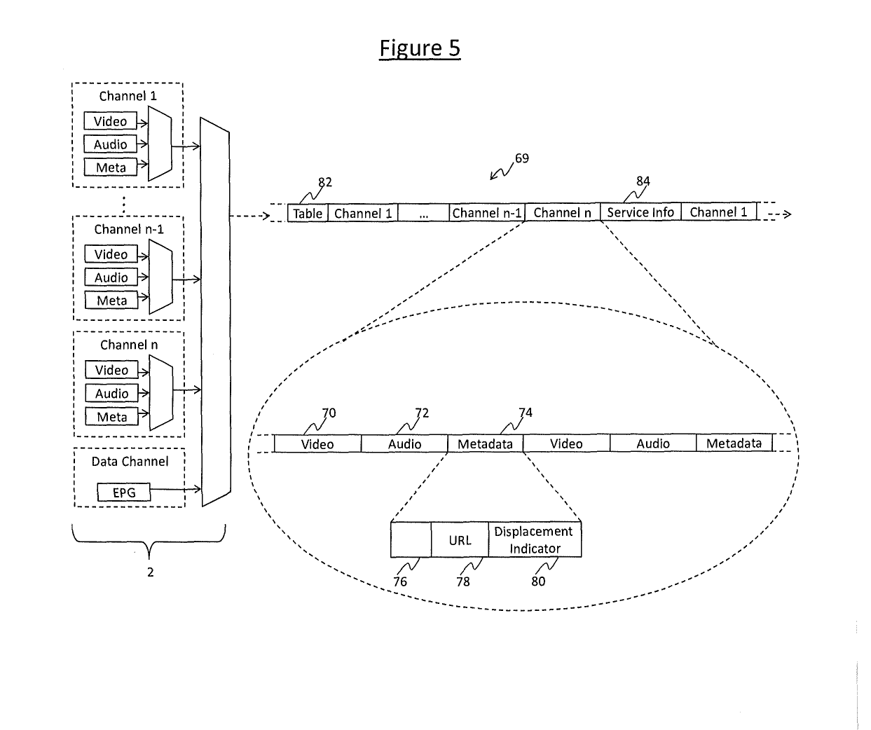

FIG. 5 provides a schematic illustration of a transport stream 69 as might be broadcast to a set-top box 4 from a television network 2 (or transmitted from an IP television network 11, 1′).

The transport stream comprises one or more interleaved channel streams of one or more respective television channels 1 . . . n carrying the respective program content, and typically one or more separate data streams carrying additional information such as an EPG. This set of one or more data streams may be referred to as the “service information” 84. Each of the television channels 1 . . . n and the data streams are included in a table carried in the multiplexed signal, i.e. in the transport stream (see below). Each of the television channels 1 . . . n and the data streams is also transmitted in a different respective multiplexing slot of the time-multiplexed transport stream. Different sets of channels may also be broadcast in different transport streams (not shown) on different frequencies, hence making use of both time and frequency multiplexing. The EPG need not be included in every transport stream, but could be included in only one or some of the transport streams.

Each television channel, e.g. channel n, comprises an elementary video stream 70 providing the main video content of the channel in question, i.e. the actual main scheduled program, film or commercial that the user is watching. The television channel also comprises one or more elementary audio streams 72 providing the main audio content of the channel in question, i.e. the speech, sound effects or music associated with the main video content, and may include one or more data streams containing interactive content (“carousels”).

In addition, the television channel n comprises embedded metadata 74. For example the metadata 74 may be embedded in accordance with an HbbTV standard. The metadata 74 is embedded in the particular channel n but is nonetheless a distinct part of the channel than the main video stream and main audio stream carrying the main video and audio content.

Each of the elementary streams has an identifier (ID) which is unique across a transport stream. In order to tell which elementary streams belong to which channel, in a typical broadcast scenario the transport stream includes one or more further elementary streams containing further metadata in the form of a table 82 that describes how the other elementary streams are grouped into channels (e.g. to specify that channel 1 consists of the elementary streams with the IDs 101,102, 104 and 105; channel 2 consists of the elementary streams with the IDs 202, 202, 203 and 105, etc.). That is, the table specifies which elementary streams, including their individual associated metadata, belong to each channel. This table is then used at the receiving end to determine what streams to decode and to match embedded metadata 74 to its respective individual channel. In this sense the metadata 74 is embedded in a particular channel n in that it is attached to the channel by the table 82.

As mentioned, the transport stream can also include one or more other elementary streams 84 (the “service information”) carrying metadata aimed at the end user such as EPG data describing the programmes on individual channels. Unlike the other streams and their embedded metadata 74, which are each tied to a specific channel, data in the one or more data streams 84 is associated with the transport stream as a whole rather than individual channels.

In the case of IP-delivered channels, a transport stream will only carry one channel so embedded metadata may be embedded in this way. Further, any general human-readable metadata 84 may be carried outside of the transport stream, since there is a two-way connection between the receiver and the head-end, rather than the one-way connection that exists in a traditional TV network.

By whatever means delivered, the metadata 74 comprises at least a portion 78 defining or otherwise relating to interactive content. Interactive content may be defined as content which is supplementary to the main video content 70 and main audio content 72. An interactive application may be run at the receiving end of the broadcast in order to act upon the received metadata. In accordance with embodiments of the present invention, this application is stored on a storage medium 50 of the second terminal 16 and arranged to run on the processor 46 of the second terminal 16 (e.g. as part of the controller application 56 or in conjunction with it as one of the other applications 58).

The idea of interactive content may refer to content that is summoned when the user interacts with the channel. That is, the interactive content may be accessed by at least one additional user activation supplied by the user during output of the main video content to the screen 6 (in addition and subsequent to the user activation required to initially select the television channel for output to the screen). For example this could involve pressing a certain coloured button on the remote control while the user is watching a program or commercial, thereby summoning interactive content in the form of text, graphics, supplementary video or even an application relating to some aspect of the program or the advertised product. In some cases the interactive content could involve multiple additional user interactions, e.g. in the case of an interactive application such as an interactive quiz show.

In a preferred embodiment the portion 78 defining the interactive content comprises a link such as a URL (Uniform Resource Locator) or other such network locator, linking to a server from which the interactive content can be retrieved via the Internet 20 or other such IP or packet-based network. Another option is that the metadata portion 78 may comprise a link that references content contained in the carousel carried by the broadcast stream, as opposed to a server.

Alternatively or additionally, the idea of interactive content may refer to content such as a user interface by which the user can interact, e.g. a menu screen or overlay providing the user with options for performing certain user actions to interact with the application. In this case at least elements of the interactive user interface are specified or controlled based on the portion 78 of metadata defining or relating to the interactive content. That is, the metadata 78 may comprise data that is understood by an interactive application running on the second terminal 16. For example the interactive application may be arranged to perform certain on-screen or audible actions when triggered by the metadata (e.g. as part of an interactive quiz or other game). The interactive application itself may have been linked to and downloaded based on other received metadata processed by another application.

In a particularly preferred embodiment, the metadata 74 also comprises another portion in the form of a displacement indicator 80, to be described shortly.

The metadata may also comprise yet another portion 76 defining other information. For example this other portion 76 may also define a time window in which the respective interactive content is valid for access. For example during a program a time window may be defined in which a particular product placement appears on screen (e.g. when the user sees their favourite actor wearing a particular brand of clothing). On condition that the user activates the relevant user input at time that is consistent with that time window (e.g. pressing a particular coloured button on the remote when the product is seen on screen) then he or she is provided with web content giving more information on that product or is redirected to a website on which the product can be purchased. A similar idea could be used during explicit commercials, or to provide information on recipes occurring within cookery programs, etc.

Where a time window is defined in the metadata 74, 76, this is preferably defined relative to the timing of the video stream 70 (or possibly audio stream 72) in the particular channel with which the metadata in question is associated. This could be achieved by the timing being implicit from the metatdata's embedded position or positions in the channel stream relative to the video elements 70, e.g. the window runs for a predetermined time from the occurrence of the metatdata 74 or runs between two metadata elements. Alternatively this could be achieved by including in the metadata 74, 76 an explicit definition of the time window specified in relation to synchronisation information included in the video elements 70.

Note that the sizes and order of the various different data elements 70, 72, 74, 76, 78 and 80 in FIG. 5 are only schematic and are not necessarily limiting, although it is intended to show that the different channels are preferably interleaved with one another within the transport stream 69 and the elementary streams and metadata 70, 72, 74 are preferably interleaved with one another within a given channel n.

The metadata 74 is extracted from the selected channel, e.g. channel n, at the receiving set-top box 4. In a conventional system the set-top box 4 would simply process the metadata 74 for output of the interactive content to the one television screen 6 to which the set-top box 4 is connected (or on the case of a TV set the TV's own internally housed screen).

However, in accordance with a preferred embodiment of the present invention, the first controller application 34 running on the first terminal 4 is configured to forward the metadata 74 to the second controller application 56 running on the second terminal 16, via the wireless connection established between the wireless transceiver 14 on the first terminal and wireless transceiver 18 on the second terminal 16 (and the associated drivers and protocols 44, 62 and APIs 38, 60).

Note that where it is said that metadata is transmitted or forwarded to the second terminal 16 or such like, this does not exclude the possibility that the metadata may first be reformatted to some extent, e.g. to repackage into a different packet format, or to interpret or process the metatdata and forward on instructions representing the relevant meaning of the metadata to the controller. I.e. metadata could be transmitted in raw form to the second terminal 16 or could be processed to transmit the metadata in modified form.

In an example of system operation, the user selects a chosen one of the multiple multiplexed channels to be displayed on the first screen 6 by means of a first user activation. When the user sees something in the program that he or she is interested in, he or she then performs a second user interaction to summon supplementary content. This is considered interactive content in one sense because it is not simply encoded as video into the main video stream 70 (or as audio into the main audio stream 72), but instead is defined in the channel as a metadata element 74 to be accessed by at least one second user activation (i.e. the user has to do something extra rather than just select the desired channel and then sit back and passively watch television).

The second controller application 56 on the second terminal 16 is configured to access the interactive content when the relevant user input is supplied by the user. In a preferred embodiment this comprises the second controller application 56 processing the URL 78 or other such link in order to download the interactive content from the server hosting the content on the Internet 20 or other such packet-switched data network. In the case where the interactive content results from the user being directed to a website, the access to this content may also comprise the second controller application 56 sending information on the uplink to the server on the Internet 20 where the site is hosted, e.g. to supply payment details for online purchases relating to product placements or commercials seen in the main video 70.

When access to the interactive content by the second controller 56 is via a URL or such like, the second terminal 16 may be arranged to access this content via one or more of a number of possible means of connection to the Internet 20—either directly from the second terminal 16 via the wireless transceiver 18 and router 15, or the cellular connection 48; or via the connection between the two wireless transceivers 14, 18 and one of the interfaces 3, 13 on the first terminal 4.

The metadata is transmitted to the second terminal 16 and accessed during ongoing receipt and display of the program on the screen 6 of the first terminal 4, such that the interactive content is displaced to the screen 17 of the second user terminal 16 (e.g. tablet) whilst the main video content (e.g. program, film or commercial) continues to be output un-obscured to the screen 6 of the first terminal 4. Hence the described system advantageously allows access to the interactive content in a non-intrusive manner. This is particularly useful in a situation where multiple viewers are watching a particular program on the main screen 6 but only one viewer is interested in the interactive content. In this case the one viewer is able to access the interactive content at the second terminal 16 with its second screen 17, without disturbing the other viewers.

In one advantageous embodiment, the access to the interactive content is activated by the user by means of a user input at the second terminal 16. In this case, when a user sees something of interest in the main video of the program currently being displayed on the first terminal's screen 6, he or she activates a user input on the second terminal 16. For example this could comprise activating an on-screen button of a remote-control application being run on a touch-screen tablet 16 (the remote-control application either being comprised within or operating in conjunction with the second controller application 56). In response to this user input, the second controller application 56 is configured to then transmit a request to the first controller application 34 on the first terminal 4. In response to the request, the first controller 34 then forwards the current metadata associated with the currently displayed television channel n to the second controller 56 on the second terminal 16, which uses it to access the interactive content in the above-described manner. The request from the second to the first terminal and the response forwarding the metadata from the first to the second terminal are transmitted over the wireless connection between the wireless transceiver 18 on the second terminal 16 and the wireless transceiver 14 on the first terminal 4. The necessary control signalling between the controller applications 34, 56 is achieved via the APIs 38, 60.

Alternatively the first user terminal 4 could transmit metadata to the first terminal indiscriminately (without a request from the second terminal 16). The controller 56 on the second terminal 16 would then be configured to only process the metadata so as to access the interactive content on condition of detecting a user input at the second terminal 16. However this is less preferred as is it involves unnecessary traffic across the wireless connection 14, 18.

As another alternative, the access to the interactive content may be activated by the user by means of a user input at the first terminal 4, e.g. by pressing a certain coloured button on a dedicated remote control unit (RCU) of the first terminal 4 such as an infrared remote control (not shown). In this case the first controller application 34 forwards the metadata to the second controller application on condition of detecting the user input at the first terminal 4.

If a time window condition is associated with the interactive content, this may be assessed at either the first controller 34 or the second controller 56. For example the first controller may be configured to assess the time window and, in response to a request from the second controller 56, to only forward the metadata on condition that the first controller 34 determines that metadata is currently valid relative to the associated time window (i.e. that the period in the program of the main video stream 70 for which the corresponding interactive content is relevant has not elapsed). Alternatively the first controller could be configured to always respond with the most recent metadata and the second controller 56 would then assess whether it was valid relative to the associated time window.

In some embodiments, the controller application 56 on the second terminal 16 may also be configured to provide general remote control features, e.g. to change channel or access the EPG. In such embodiments, the controller application 56 on the second terminal 16 is configured to transmit instructions to the first controller 34 on the first terminal 4 via the wireless connection 14,18 and the APIs 38, 60. The first controller application 34, upon receiving an instruction from the second controller application 56, may then in turn issue instructions to the hybrid TV application layer 36, e.g. to control the TV user interface (UI). In response to instructions from the second controller application 56, the first controller application 34 may also issue requests to its operating system 32 requesting access to underlying driver and hardware resources 3, 6, 8, 10, 12, 13, 14, 24, 28, 40, 42, 43 and/or 44. Thus the user is able to change channel or operate an EPG on the screen of the first terminal 4 but controlled from the second terminal 16, e.g. by a touch-user interface on the second terminal's screen 17.

In further embodiments, the second controller application 56 is also configured to be able to make use of the demultiplexer 8 on the first terminal 4 to retrieve the EPG from the data channel, from amongst the multiplexed television channels and data channel, and to receive the EPG over the wireless connection 14,18. The EPG can then be displayed on the screen 17 of the second terminal and operated on the second terminal 16.

Further, the second controller application 56 may be configured to fetch and mimic the user interface of the first terminal 4 on the screen 17 of the second terminal 16.

According to the above, a controller application running on a second screen such as a tablet can therefore be used whilst the user is watching TV as an extension to the main on-screen activity. Visual elements (such as the interactive content and EPG) will preferably be styled to be recognisably from the same brand as the STB EPG and therefore may reuse some of the graphical elements. The design and the layout of the interactive content and EPG will be similar to the STB content and EPG but will be first and foremost designed to be a good tablet implementation of such. For example use of swipe to scroll, pop-ups to show more info, finger size buttons, full screen display, etc.

In embodiments, the signal processing module 10 may comprise a security module configured to decrypt the television channel, including its respective metadata, from a first encryption standard used to broadcast over the television network 2. The signal processing module 10 may be configured to re-encrypt the metadata according to a second encryption standard appropriate for transmission over the wireless connection 14, 18 between the first and second terminals 4, 16. The signal processing module 61 on the second terminal then comprises its own decryption module configured to decrypt the metadata from the second encryption standard into clear form for use in accessing the interactive content. This re-encryption process is particularly useful as television network operators may not allow unencrypted content to be transmitted via the wireless connection 14, 18, but on the other hand the encryption standard used over the TV network 2 may not be one that is convenient to decode at the second terminal.

As mentioned, in a particularly preferred embodiment the metadata 74 comprises an additional potion 80 referred to herein as a displacement indicator. This could be included as a new field in the metadata format as part of an update to an existing standard, or could be inserted in an existing “free” field of an existing standard. For example the existing standard could be an HbbTV standard.

The displacement indicator 80 portion allows the broadcaster or other provider of the television channel to specify whether the interactive content defined by the accompanying portion 76 in the metadata 74 is intended to be accessed using the screen 6 of the first terminal 4 or the screen 17 of the second terminal 16, i.e. whether it is specified that the corresponding interactive content should be displaced to the second terminal 16 or kept at the first terminal 4. In embodiments the displacement indicator 80 need only be a one-bit flag.

For example, interactive content associated with product placement in a television program such as a drama may be specified as most suited to being displaced to the screen 17 of the second terminal 16 so that it does not disrupt viewing of the main program. On the other hand an interactive quiz application may be most suited to being displayed in conjunction with the main program on the screen 6 of the first terminal 4 if the quiz application is intended to appear as an integral part of the main quiz program.

The first controller 34 on the first terminal 4 is configured to extract and process the displacement indicator 80 in order to determine whether or not displacement of the interactive content is specified by the broadcaster or provider.

Preferably, when access to interactive content is triggered, either by a request from the second controller 56 on the second terminal 16 or by a user input at the first terminal 4, the first controller 34 on the first terminal 4 is configured to automatically enact the decision as to whether the interactive content will be displayed on the first terminal 4 or displaced to the second terminal 16 (or in a different implementation the second controller could remotely read the indicator 80 and make the decision as to whether to retrieve the interactive content). Therefore in a preferred embodiment the user need do nothing more than activate the user input that requests interactive content and the content is then automatically provided via whichever terminal 4 or 16 that the broadcaster or provider has deemed most suited to that content.

Alternatively the displacement need not be automatic and instead the user could be provided with the options of whether to displace or not, highlighting one option as that specified by the provider or broadcaster.

In other alternative embodiments, the decision as to whether to displace content to the second terminal 16 could be based on whether the user activates a user input at the first terminal 4 or second terminal 16. I.e. if the first controller 34 receives a request for interactive content from the second controller 56 via the wireless connection 14, 18 it may automatically displace the interactive content to the second terminal 16, but if the user requests interactive content using a user input of the first terminal 4 such as a dedicated infrared RCU then it may keep the interactive content at the first terminal 4. As another alternative, the displacement decision could be based on a user setting, or a combination of any of the above factors.

It will be appreciated that the above embodiments have been described only by way of example. Other variants may become apparent to a person skilled in the art given the disclosure herein. The scope of the present invention is not limited by the described embodiments but only by the appendant claims.

1. A system comprising:
a first user terminal comprising a television receiver for receiving a selected television channel, the television channel being selected by a first user activation and comprising a main video stream, and the first terminal further comprising a first controller and an output for outputting the main video stream of the selected television channel to a first screen; and
a second user terminal comprising a second screen, a wireless transceiver operable to establish a wireless connection with the first terminal, and a second controller configured to communicate with the first controller via the wireless connection;
wherein the television receiver of the first terminal is arranged to receive metadata relating to interactive content associated with the main video stream, and the first controller is operable to forward at least a portion of the metadata to the second terminal via said wireless connection; and the second controller is configured to process said portion of metadata and to output the interactive content to the second screen, such that the interactive content is displaced to the screen of the second terminal whilst the main video stream of the television channel continues to be displayed on the screen of the first terminal; and
wherein the metadata is embedded in the television channel and includes a displacement indicator indicating whether the first terminal or the second terminal has been specified by a provider for output of the interactive content, and at least one of the first controller and the second controller is configured to extract and process said displacement indicator in order to determine whether or not displacement of the interactive content is specified by the provider.

2. The system of claim 1, wherein the interactive content comprises an interactive application run on the second user terminal when displaced to the second terminal.

3. The system of claim 2, wherein at least one of the first controller and the second controller is configured such that said processing comprises, automatically displacing the interactive content to the second terminal on condition that the indicator indicates the second terminal.

4. The system of claim 1, wherein: the interactive content comprises content to be accessed in response to a second user activation supplied during output of the main video stream to the first screen; and the second controller is configured to process said portion of metadata and to output the interactive content to the second screen in response to the second user activation.

5. The system of claim 4, wherein the second controller is configured to receive said second user activation via a user input of the second terminal.

6. The system of claim 5, wherein the second controller is configured to request said portion of metadata from the first terminal in response to the second user activation, and the first controller is configured to transmit the portion of metadata to the second terminal via the wireless connection in response to said request.

7. The system of claim 4, wherein the metadata comprises a link to a server, said portion comprises at least the link, and the second controller is configured to retrieve the interactive content from the server via a packet-based network based on the link as received over said wireless connection.

8. The system of claim 4, wherein the metadata defines a time window defined relative to the main video stream, and at least one of the first controller and the second controller is configured such that access to the interactive content is conditional on said second user activation being supplied at a time consistent with said time window.

9. (canceled)

10. The system of claim 1, wherein the television receiver of the first terminal is further arranged to receive a data channel comprising an electronic program guide, in addition to said television channel and said metadata.

11. The system of claim 10, wherein the second controller is further configured to receive the electronic program guide from the television receiver of the first terminal via the wireless connection, and to operate the electronic program guide via the screen of the second terminal.

12. The system of claim 1, wherein the second controller is further configured to receive a user interface from the first terminal via the wireless connection, and to operate the user interface via the screen of the second terminal.

13. The system of claim 1, wherein the controller on the second terminal is further configured to schedule recordings of television programs on the first terminal and control playback of the recordings via the wireless connection.

14. The system of claim 1, wherein the television receiver comprises: a receiving interface at which a plurality of concurrent multiplexed television channels are concurrently made available from a television network, each television channel comprising a respective video stream, and a demultiplexer arranged to demultiplex the selected television channel from amongst said television channels.

15. The system of claim 14, wherein the receiving interface comprises an input from at least one of a satellite dish and a radio-frequency antenna, at which the plurality of television channels are made available on a plurality of different frequency bands, and the demultiplexer comprises a television tuner operable to tune to the frequency band of the selected television channel.

16. The system of claim 14, wherein the first terminal comprises a wireless transceiver other than said television receiver, for establishing said wireless connection with the second terminal.

17. The system of claim 7, wherein at least one of the first terminal and the second terminal comprises a network interface other than the receiving interface from the television network, the network interface providing access to said packet-based network, being a network other than said television network, for retrieval of the interactive content from said server.

18. (canceled)

19. The system of claim 1, wherein the first terminal is one of: a television set comprising said screen, and set-top box for plugging into said television screen.

20. The system of claim 1, wherein the second terminal is a portable terminal.

21. (canceled)

22. (canceled)

23. (canceled)

24. A computer program product for displacing interactive content from a first terminal to a screen of a second terminal, the computer program product being embodied on a non-transient computer-readable medium and configured so as when executed on a processor to perform the operations of the first controller comprising:
receiving a main video stream, and the first terminal further comprising a first controller and an output for outputting the main video stream to a first screen;
receiving metadata relating to interactive content associated with the main video stream; and
forwarding at least a portion of the metadata to the second terminal via said wireless connection;
wherein the second controller is configured to process said portion of metadata and to output the interactive content to the second screen, such that the interactive content is displaced to the screen of the second terminal whilst the main video stream continues to be displayed on the screen of the first terminal; the metadata is embedded in main video stream and includes a displacement indicator indicating whether the first terminal or the second terminal has been specified by a provider for output of the interactive content, and at least one of the first controller and the second controller is configured to extract and process said displacement indicator in order to determine whether or not displacement of the interactive content is specified by the provider.

25. A computer program product for displacing interactive content from a first terminal to a screen of a second terminal, the computer program product being embodied on a non-transient computer-readable medium and configured so as when executed on a processor to perform the operations of the second controller according to any of claims 1 to 18 comprising a second screen, a wireless transceiver operable to establish a wireless connection with the first terminal, and a second controller configured to communicate with the first controller via the wireless connection; the computer program product for:
processing a portion of metadata received from the first terminal, the metadata relating to interactive content associated with a main video stream; and
outputting the interactive content to the second screen, such that the interactive content is displaced to the screen of the second terminal whilst the main video stream continues to be displayed on a first screen of the first terminal;
wherein the first user terminal comprising a television receiver for receiving the main video stream, and the first terminal further comprising a first controller and an output for outputting the main video stream to the first screen, and the first terminal is arranged to receive and forward at least a portion of the metadata to the second terminal via said wireless connection; the metadata is embedded in the video stream and includes a displacement indicator indicating whether the first terminal or the second terminal has been specified by a provider for output of the interactive content, and at least one of the first controller and the second controller is configured to extract and process said displacement indicator in order to determine whether or not displacement of the interactive content is specified by a provider.
